(19) United States
(12) Patent Application Publication
(10) Pub. No.: US 2013/0146802 A1
(43) Pub. Date: Jun. 13, 2013

(54) FERRITE MAGNETIC MATERIALS

(71) Applicants: Chih-Wen CHEN, Tainan City (TW); Mean-Jue Tung, Jincheng Township (TW)

(72) Inventors: Chih-Wen CHEN, Tainan City (TW); Mean-Jue Tung, Jincheng Township (TW)

(21) Appl. No.: 13/361,273

(22) Filed: Jan. 30, 2012

(30) Foreign Application Priority Data
Dec. 9, 2011 (TW) 100145514

(51) Int. Cl. H01F 1/01

(52) U.S. Cl. 252/62.61

(57) ABSTRACT

In an embodiment of the invention, a ferrite magnetic material is provided. The ferrite magnetic material has the following formula.

(NiₐCu_{b}Zn_{c}Mn_{d}MgₑLi_{f}Co_{g})ₓFe_{y}O_{z}

In the formula, x+y=2.5-3.5, y+z=5.5-6.5, y=1.70-2.40, a=0.08-0.22, b=0.03-0.23, c=0.09-0.42, d=0.12-0.31, e=0.01-0.21, f=0.06-0.42 and g=0-0.06. In an embodiment, x+y=2.5-3.5, y+z=5.5-6.5, y=1.70-2.30, a=0.13-0.22, b=0.07-0.20, c=0.09-0.40, d=0.13-0.22, e=0.01-0.21, f=0.29-0.40 and g=0. In an embodiment, x+y=2.5-3.5, y+z=5.5-6.5, y=1.90-2.40, a=0.08-0.22, b=0.03-0.23, c=0.32-0.42, d=0.13-0.31, e=0.01-0.08, f=0.14-0.42 and g=0. In an embodiment, x+y=2.5-3.5, y+z=5.5-6.5, y=1.70-2.30, a=0.09-0.20, b=0.07-0.20, c=0.13-0.32, d=0.13-0.24, e=0.07-0.20, f=0.29-0.38 and g=0. In an embodiment, x+y=2.5-3.5, y+z=5.5-6.5, y=1.70-2.10, a=0.13-0.20, b=0.13-0.20, c=0.13-0.20, d=0.13-0.20, e=0.13-0.20, f=0.29-0.36 and g=0. In an embodiment, x+y=2.5-3.5, y+z=5.5-6.5, y=1.90-2.30, a=0.12-0.22, b=0.07-0.20, c=0.30-0.39, d=0.13-0.24, e=0.01-0.08, f=0.06-0.21 and g=0. In an embodiment, x+y=2.5-3.5, y+z=5.5-6.5, y=1.70-2.10, a=0.12-0.20, b=0.12-0.20, c=0.12-0.20, d=0.12-0.20, e=0.12-0.20, f=0.27-0.37 and g=0-0.06.

### CROSS REFERENCE TO RELATED APPLICATIONS

This Application claims priority of Taiwan Patent Application No. 100145514, filed on Dec. 9, 2011, the entirety of which is incorporated by reference herein.

### BACKGROUND OF THE INVENTION

1. Field of the Invention

The invention relates to a ferrite magnetic material, and more particularly to a ferrite magnetic material with high saturation magnetic flux density and low cost.

2. Description of the Related Art

During the development of ferrite magnetic materials, the cost of raw materials thereof is unavoidable. If the cost of raw materials can be decreased, product profitability increases. Nowadays, soft ferrite magnetic materials are mainly divided into a nickel-zinc ferrite magnet, and a manganese-zinc ferrite magnet, even though a lithium ferrite magnet has been developed.

### BRIEF SUMMARY OF THE INVENTION

One embodiment of the invention provides a ferrite magnetic material having the following formula.

(NiₐCu_{b}Zn_{c}Mn_{d}MgₑLi_{f}Co_{g})ₓFe_{y}O_{z}

In the formula, x+y=2.5-3.5, y+z=5.5-6.5, y=1.70-2.40, a=0.08-0.22, b=0.03-0.23, c=0.09-0.42, d=0.12-0.31, e=0.01-0.21, f=0.06-0.42 and g=0-0.06.

The invention provides a multi-component ferrite magnetic material with high saturation magnetic flux density and low cost which is produced through adjusting of the ratio of the raw materials such as iron oxide, nickel oxide, manganese oxide (or manganese carbonate), copper oxide, zinc oxide, lithium oxide (lithium carbonate), and magnesium oxide. When soft ferrite magnetic materials contain the above-mentioned raw materials, high saturation magnetic flux density thereof can be achieved and the cost thereof is lower than that of the current ferrite magnetic materials (due to using a lesser amount of the high- cost nickel oxide raw material).

A detailed description is given in the following embodiments.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

One embodiment of the invention provides a ferrite magnetic material having the following formula.

(NiₐCu_{b}Zn_{c}Mn_{d}MgₑLi_{f}Co_{g})ₓFe_{y}O_{z}

In the formula, x+y=2.5-3.5, y+z=5.5-6.5, y=1.70-2.40, a=0.08-0.22, b=0.03-0.23, c=0.09-0.42, d=0.12-0.31, e=0.01-0.21, f=0.06-0.42 and g=0-0.06.

In an embodiment, x+y=2.5-3.5, y+z=5.5-6.5, y=1.70-2.30, a=0.13-0.22, b=0.07-0.20, c=0.09-0.40, d=0.13-0.22, e=0.01-0.21, f=0.29-0.40 and g=0.

In an embodiment, x+y=2.5-3.5, y+z=5.5-6.5, y=1.90-2.40, a=0.08-0.22, b=0.03-0.23, c=0.32-0.42, d=0.13-0.31, e=0.01-0.08, f=0.14-0.42 and g=0.

In an embodiment, x+y=2.5-3.5, y+z=5.5-6.5, y=1.70-2.30, a=0.09-0.20, b=0.07-0.20, c=0.13-0.32, d=0.13-0.24, e=0.07-0.20, f=0.29-0.38 and g=0.

In an embodiment, x+y=2.5-3.5, y+z=5.5-6.5, y=1.70-2.10, a=0.13-0.20, b=0.13-0.20, c=0.13-0.20, d=0.13-0.20, e=0.13-0.20, f=0.29-0.36 and g=0.

In an embodiment, x+y=2.5-3.5, y+z=5.5-6.5, y=1.90-2.30, a=0.12-0.22,b=0.07-0.20, c=0.30-0.39, d=0.13-0.24, e=0.01-0.08, f=0.06-0.21 and g=0.

In an embodiment, x+y=2.5-3.5, y+z=5.5-6.5, y=1.70-2.10, a=0.12-0.20, b=0.12-0.20, c=0.12-0.20, d=0.12-0.20, e=0.12-0.20, f=0.27-0.37 and g=0-0.06.

The invention provides a multi-component ferrite magnetic material with high saturation magnetic flux density and low cost which is produced through adjusting of the ratio of the raw materials such as iron oxide, nickel oxide, manganese oxide (or manganese carbonate), copper oxide, zinc oxide, lithium oxide (lithium carbonate), and magnesium oxide. When soft ferrite magnetic materials contain the above-mentioned raw materials, high saturation magnetic flux density thereof can be achieved and the cost thereof is lower than that of the current ferrite magnetic materials (due to using a lesser amount of the high-cost nickel oxide raw material).

### EXAMPLE 1

### Preparation of the Ferrite Magnetic Material (1) and Permeability and Saturation Magnetic Flux Density thereof

48.4 mol % of iron oxide, 8.6 mol % of nickel oxide, 11 mol % of zinc oxide, 7.4 mol % of copper oxide, 8.6 mol % of manganese oxide, 8.6 mol % of lithium carbonate, and 7.4 mol % of magnesium oxide were wet-mixed, calcined at 750° C., ball-milled and dried. After sintering at 1,100° C., a sample was obtained.

The permeability of the sample was measured by an Agilent E4991A impedance/material analyzer. The permeability thereof was 42 (at 1 MHz). The saturation magnetic flux density of the sample was measured by a BHU-60 BH curve tracer (Riken Denshi model). The saturation magnetic flux density thereof was 2994 Gauss.

### EXAMPLE 2

### Preparation of the Ferrite Magnetic Material (2) and Permeability and Saturation Magnetic Flux Density thereof

48.4 mol % of iron oxide, 8.6 mol % of nickel oxide, 12 mol % of zinc oxide, 6.9 mol % of copper oxide, 8.6 mol % of manganese oxide, 8.6 mol % of lithium carbonate, and 6.9 mol % of magnesium oxide were wet-mixed, calcined at 750° C., ball-milled and dried. After sintering at 1,150° C., a sample was obtained.

The permeability of the sample was measured by an Agilent E4991A impedance/material analyzer. The permeability thereof was 48 (at 1 MHz). The saturation magnetic flux density of the sample was measured by a BHU-60 BH curve tracer (Riken Denshi model). The saturation magnetic flux density thereof was 2935 Gauss.

### EXAMPLE 3

### Preparation of the Ferrite Magnetic Material (3) and Permeability and Saturation Magnetic Flux Density thereof

48.4 mol % of iron oxide, 8.6 mol % of nickel oxide, 13 mol % of zinc oxide, 6.4 mol % of copper oxide, 8.6 mol % of manganese oxide, 8.6 mol % of lithium carbonate, and 6.4 mol % of magnesium oxide were wet-mixed, calcined at 750° C., ball-milled and dried. After sintering at 1,150° C., a sample was obtained.

The permeability of the sample was measured by an Agilent E4991A impedance/material analyzer. The permeability thereof was 55 (at 1 MHz). The saturation magnetic flux density of the sample was measured by a BHU-60 BH curve tracer (Riken Denshi model). The saturation magnetic flux density thereof was 3090 Gauss.

### EXAMPLE 4

### Preparation of the Ferrite Magnetic Material (4) and Permeability and Saturation Magnetic Flux Density thereof

48.4 mol % of iron oxide, 8.6 mol % of nickel oxide, 14 mol % of zinc oxide, 5.9 mol % of copper oxide, 8.6 mol % of manganese oxide, 8.6 mol % of lithium carbonate, and 5.9 mol % of magnesium oxide were wet-mixed, calcined at 750° C., ball-milled and dried. After sintering at 1,150° C., a sample was obtained.

The permeability of the sample was measured by an Agilent E4991A impedance/material analyzer. The permeability thereof was 60 (at 1 MHz). The saturation magnetic flux density of the sample was measured by a BHU-60 BH curve tracer (Riken Denshi model). The saturation magnetic flux density thereof was 3114 Gauss.

### EXAMPLE 5

### Preparation of the Ferrite Magnetic Material (5) and Permeability and Saturation Magnetic Flux Density thereof

48.4 mol % of iron oxide, 8.6 mol % of nickel oxide, 15 mol % of zinc oxide, 5.4 mol % of copper oxide, 8.6 mol % of manganese oxide, 8.6 mol % of lithium carbonate, and 5.4 mol % of magnesium oxide were wet-mixed, calcined at 750° C., ball-milled and dried. After sintering at 1,150° C., a sample was obtained.

The permeability of the sample was measured by an Agilent E4991A impedance/material analyzer. The permeability thereof was 65 (at 1 MHz). The saturation magnetic flux density of the sample was measured by a BHU-60 BH curve tracer (Riken Denshi model). The saturation magnetic flux density thereof was 3171 Gauss.

### EXAMPLE 6

### Preparation of the Ferrite Magnetic Material (6) and Permeability and Saturation Magnetic Flux Density thereof

48.4 mol % of iron oxide, 8.6 mol % of nickel oxide, 16 mol % of zinc oxide, 5.9 mol % of copper oxide, 8.6 mol % of manganese oxide, 8.6 mol % of lithium carbonate, and 3.9 mol % of magnesium oxide were wet-mixed, calcined at 750° C., ball-milled and dried. After sintering at 1,100° C., a sample was obtained.

The permeability of the sample was measured by an Agilent E4991A impedance/material analyzer. The permeability thereof was 71 (at 1 MHz). The saturation magnetic flux density of the sample was measured by a BHU-60 BH curve tracer (Riken Denshi model). The saturation magnetic flux density thereof was 3237 Gauss.

### EXAMPLE 7

### Preparation of the Ferrite Magnetic Material (7) and Permeability and Saturation Magnetic Flux Density thereof

48.4 mol % of iron oxide, 8.6 mol % of nickel oxide, 17 mol % of zinc oxide, 5.4 mol % of copper oxide, 8.6 mol % of manganese oxide, 8.6 mol % of lithium carbonate, and 3.4 mol % of magnesium oxide were wet-mixed, calcined at 750° C., ball-milled and dried. After sintering at 1,150° C., a sample was obtained.

The permeability of the sample was measured by an Agilent E4991A impedance/material analyzer. The permeability thereof was 89 (at 1 MHz). The saturation magnetic flux density of the sample was measured by a BHU-60 BH curve tracer (Riken Denshi model). The saturation magnetic flux density thereof was 3182 Gauss.

### EXAMPLE 8

### Preparation of the Ferrite Magnetic Material (8) and Permeability and Saturation Magnetic Flux Density thereof

48.4 mol % of iron oxide, 8.6 mol % of nickel oxide, 18 mol % of zinc oxide, 5.9 mol % of copper oxide, 8.6 mol % of manganese oxide, 8.6 mol % of lithium carbonate, and 1.9 mol % of magnesium oxide were wet-mixed, calcined at 750° C., ball-milled and dried. After sintering at 1,150° C., a sample was obtained.

The permeability of the sample was measured by an Agilent E4991A impedance/material analyzer. The permeability thereof was 94 (at 1 MHz). The saturation magnetic flux density of the sample was measured by a BHU-60 BH curve tracer (Riken Denshi model). The saturation magnetic flux density thereof was 3196 Gauss.

### EXAMPLE 9

### Preparation of the Ferrite Magnetic Material (9) and Permeability and Saturation Magnetic Flux Density thereof

48.4 mol % of iron oxide, 8.6 mol % of nickel oxide, 19 mol % of zinc oxide, 5.4 mol % of copper oxide, 8.6 mol % of manganese oxide, 8.6 mol % of lithium carbonate, and 1.4 mol % of magnesium oxide were wet-mixed, calcined at 750° C., ball-milled and dried. After sintering at 1,150° C., a sample was obtained.

The permeability of the sample was measured by an Agilent E4991A impedance/material analyzer. The permeability thereof was 103 (at 1 MHz). The saturation magnetic flux density of the sample was measured by a BHU-60 BH curve tracer (Riken Denshi model). The saturation magnetic flux density thereof was 3159 Gauss.

### EXAMPLE 10

### Preparation of the Ferrite Magnetic Material (10) and Permeability and Saturation Magnetic Flux Density thereof

48.4 mol % of iron oxide, 8.6 mol % of nickel oxide, 8.6 mol % of zinc oxide, 8.6 mol % of copper oxide, 8.6 mol % of manganese oxide, 8.6 mol % of lithium carbonate, and 8.6 mol % of magnesium oxide were wet-mixed, calcined at 750° C., ball-milled and dried. After sintering at 1,100° C., a sample was obtained.

The permeability of the sample was measured by an Agilent E4991A impedance/material analyzer. The permeability thereof was 32 (at 1 MHz). The saturation magnetic flux density of the sample was measured by a BHU-60 BH curve tracer (Riken Denshi model). The saturation magnetic flux density thereof was 2689 Gauss.

### EXAMPLE 11

### Preparation of the Ferrite Magnetic Material (11) and Permeability and Saturation Magnetic Flux Density thereof

48.4 mol % of iron oxide, 8.6 mol % of nickel oxide, 8.6 mol % of zinc oxide, 8.6 mol % of copper oxide, 8.6 mol % of manganese oxide, 8.6 mol % of lithium carbonate, and 8.6 mol % of magnesium oxide were wet-mixed, calcined at 750° C., ball-milled and dried. After sintering at 1,200° C., a sample was obtained.

The permeability of the sample was measured by an Agilent E4991A impedance/material analyzer. The permeability thereof was 27 (at 1 MHz). The saturation magnetic flux density of the sample was measured by a BHU-60 BH curve tracer (Riken Denshi model). The saturation magnetic flux density thereof was 2627 Gauss.

### EXAMPLE 12

### Preparation of the Ferrite Magnetic Material (12) and Permeability and Saturation Magnetic Flux Density thereof

48.4 mol % of iron oxide, 8.6 mol % of nickel oxide, 11 mol % of zinc oxide, 7.4 mol % of copper oxide, 10 mol % of manganese oxide, 8.6 mol % of lithium carbonate, and 6 mol % of magnesium oxide were wet-mixed, calcined at 750° C., ball-milled and dried. After sintering at 1,100° C., a sample was obtained.

The permeability of the sample was measured by an Agilent E4991A impedance/material analyzer. The permeability thereof was 44 (at 1 MHz). The saturation magnetic flux density of the sample was measured by a BHU-60 BH curve tracer (Riken Denshi model). The saturation magnetic flux density thereof was 3027 Gauss.

### EXAMPLE 13

### Preparation of the Ferrite Magnetic Material (13) and Permeability and Saturation Magnetic Flux Density thereof

48.4 mol % of iron oxide, 10 mol % of nickel oxide, 6.6 mol % of zinc oxide, 8.6 mol % of copper oxide, 8.6 mol % of manganese oxide, 8.6 mol % of lithium carbonate, and 9.2 mol % of magnesium oxide were wet-mixed, calcined at 750° C., ball-milled and dried. After sintering at 1,150° C., a sample was obtained.

The permeability of the sample was measured by an Agilent E4991A impedance/material analyzer. The permeability thereof was 28 (at 1 MHz). The saturation magnetic flux density of the sample was measured by a BHU-60 BH curve tracer (Riken Denshi model). The saturation magnetic flux density thereof was 2713 Gauss.

### EXAMPLE 14

### Preparation of the Ferrite Magnetic Material (14) and Permeability and Saturation Magnetic Flux Density thereof

48.4 mol % of iron oxide, 10 mol % of nickel oxide, 11 mol % of zinc oxide, 7.4 mol % of copper oxide, 8.6 mol % of manganese oxide, 8.6 mol % of lithium carbonate, and 6 mol % of magnesium oxide were wet-mixed, calcined at 750° C., ball-milled and dried. After sintering at 1,050° C., a sample was obtained.

The permeability of the sample was measured by an Agilent E4991A impedance/material analyzer. The permeability thereof was 45 (at 1 MHz). The saturation magnetic flux density of the sample was measured by a BHU-60 BH curve tracer (Riken Denshi model). The saturation magnetic flux density thereof was 3044 Gauss.

### EXAMPLE 15

### Preparation of the Ferrite Magnetic Material (15) and Permeability and Saturation Magnetic Flux Density thereof

48.9 mol % of iron oxide, 8.6 mol % of nickel oxide, 16 mol % of zinc oxide, 5.9 mol % of copper oxide, 8.6 mol % of manganese oxide, 8.6 mol % of lithium carbonate, and 3.4 mol % of magnesium oxide were wet-mixed, calcined at 750° C., ball-milled and dried. After sintering at 1,100° C., a sample was obtained.

The permeability of the sample was measured by an Agilent E4991A impedance/material analyzer. The permeability thereof was 64 (at 1 MHz). The saturation magnetic flux density of the sample was measured by a BHU-60 BH curve tracer (Riken Denshi model). The saturation magnetic flux density thereof was 3083 Gauss.

### EXAMPLE 16

### Preparation of the Ferrite Magnetic Material (16) and Permeability and Saturation Magnetic Flux Density thereof

49.4 mol % of iron oxide, 8.6 mol % of nickel oxide, 16 mol % of zinc oxide, 5.9 mol % of copper oxide, 8.6 mol % of manganese oxide, 8.6 mol % of lithium carbonate, and 2.9 mol % of magnesium oxide were wet-mixed, calcined at 750° C., ball-milled and dried. After sintering at 1,100° C., a sample was obtained.

The permeability of the sample was measured by an Agilent E4991A impedance/material analyzer. The permeability thereof was 77 (at 1 MHz). The saturation magnetic flux density of the sample was measured by a BHU-60 BH curve tracer (Riken Denshi model). The saturation magnetic flux density thereof was 3249 Gauss.

### EXAMPLE 17

### Preparation of the Ferrite Magnetic Material (17) and Permeability and Saturation Magnetic Flux Density thereof

49.9 mol % of iron oxide, 8.6 mol % of nickel oxide, 16 mol % of zinc oxide, 5.9 mol % of copper oxide, 8.6 mol % of manganese oxide, 8.6 mol % of lithium carbonate, and 2.4 mol % of magnesium oxide were wet-mixed, calcined at 750° C., ball-milled and dried. After sintering at 1,150° C., a sample was obtained.

The permeability of the sample was measured by an Agilent E4991A impedance/material analyzer. The permeability thereof was 67 (at 1 MHz). The saturation magnetic flux density of the sample was measured by a BHU-60 BH curve tracer (Riken Denshi model). The saturation magnetic flux density thereof was 3073 Gauss.

### EXAMPLE 18

### Preparation of the Ferrite Magnetic Material (18) and Permeability and Saturation Magnetic Flux Density thereof

50.4 mol % of iron oxide, 8.6 mol % of nickel oxide, 16 mol % of zinc oxide, 5.9 mol % of copper oxide, 8.6 mol % of manganese oxide, 8.6 mol % of lithium carbonate, and 1.9 mol % of magnesium oxide were wet-mixed, calcined at 750° C., ball-milled and dried. After sintering at 1,100° C., a sample was obtained.

The permeability of the sample was measured by an Agilent E4991A impedance/material analyzer. The permeability thereof was 77 (at 1 MHz). The saturation magnetic flux density of the sample was measured by a BHU-60 BH curve tracer (Riken Denshi model). The saturation magnetic flux density thereof was 3299 Gauss.

### EXAMPLE 19

### Preparation of the Ferrite Magnetic Material (19) and Permeability and Saturation Magnetic Flux Density thereof

50.9 mol % of iron oxide, 8.6 mol % of nickel oxide, 16 mol % of zinc oxide, 4.9 mol % of copper oxide, 8.6 mol % of manganese oxide, 8.6 mol % of lithium carbonate, and 2.4 mol % of magnesium oxide were wet-mixed, calcined at 750° C., ball-milled and dried. After sintering at 1,150° C., a sample was obtained.

The permeability of the sample was measured by an Agilent E4991A impedance/material analyzer. The permeability thereof was 67 (at 1 MHz). The saturation magnetic flux density of the sample was measured by a BHU-60 BH curve tracer (Riken Denshi model). The saturation magnetic flux density thereof was 3153 Gauss.

### EXAMPLE 20

### Preparation of the Ferrite Magnetic Material (20) and Permeability and Saturation Magnetic Flux Density thereof

51.4 mol % of iron oxide, 8.6 mol % of nickel oxide, 16 mol % of zinc oxide, 4.9 mol % of copper oxide, 8.6 mol % of manganese oxide, 8.6 mol % of lithium carbonate, and 1.9 mol % of magnesium oxide were wet-mixed, calcined at 750° C., ball-milled and dried. After sintering at 1,100° C., a sample was obtained.

The permeability of the sample was measured by an Agilent E4991A impedance/material analyzer. The permeability thereof was 83 (at 1 MHz). The saturation magnetic flux density of the sample was measured by a BHU-60 BH curve tracer (Riken Denshi model). The saturation magnetic flux density thereof was 3423 Gauss.

### EXAMPLE 21

### Preparation of the Ferrite Magnetic Material (21) and Permeability and Saturation Magnetic Flux Density thereof

51.9 mol % of iron oxide, 8.6 mol % of nickel oxide, 16 mol % of zinc oxide, 4.9 mol % of copper oxide, 8.6 mol % of manganese oxide, 8.6 mol % of lithium carbonate, and 1.4 mol % of magnesium oxide were wet-mixed, calcined at 750° C., ball-milled and dried. After sintering at 1,100° C., a sample was obtained.

The permeability of the sample was measured by an Agilent E4991A impedance/material analyzer. The permeability thereof was 72 (at 1 MHz). The saturation magnetic flux density of the sample was measured by a BHU-60 BH curve tracer (Riken Denshi model). The saturation magnetic flux density thereof was 3369 Gauss.

### EXAMPLE 22

### Preparation of the Ferrite Magnetic Material (22) and Permeability and Saturation Magnetic Flux Density thereof

52.4 mol % of iron oxide, 8.6 mol % of nickel oxide, 16 mol % of zinc oxide, 4.9 mol % of copper oxide, 8.6 mol % of manganese oxide, 8 mol % of lithium carbonate, and 1.5 mol % of magnesium oxide were wet-mixed, calcined at 750° C., ball-milled and dried. After sintering at 1,100° C., a sample was obtained.

The permeability of the sample was measured by an Agilent E4991A impedance/material analyzer. The permeability thereof was 77 (at 1 MHz). The saturation magnetic flux density of the sample was measured by a BHU-60 BH curve tracer (Riken Denshi model). The saturation magnetic flux density thereof was 3626 Gauss.

### EXAMPLE 23

### Preparation of the Ferrite Magnetic Material (23) and Permeability and Saturation Magnetic Flux Density thereof

52.9 mol % of iron oxide, 5.35 mol % of nickel oxide, 16 mol % of zinc oxide, 6.5 mol % of copper oxide, 11.36 mol % of manganese oxide, 5.68 mol % of lithium carbonate, and 2.22 mol % of magnesium oxide were wet-mixed, calcined at 750° C., ball-milled and dried. After sintering at 1,100° C., a sample was obtained.

The permeability of the sample was measured by an Agilent E4991A impedance/material analyzer. The permeability thereof was 85 (at 1 MHz). The saturation magnetic flux density of the sample was measured by a BHU-60 BH curve tracer (Riken Denshi model). The saturation magnetic flux density thereof was 3781 Gauss.

### EXAMPLE 24

### Preparation of the Ferrite Magnetic Material (24) and Permeability and Saturation Magnetic Flux Density thereof

52.9 mol % of iron oxide, 6.35 mol % of nickel oxide, 16 mol % of zinc oxide, 7 mol % of copper oxide, 10.36 mol % of manganese oxide, 5.18 mol % of lithium carbonate, and 2.22 mol % of magnesium oxide were wet-mixed, calcined at 750° C., ball-milled and dried. After sintering at 1,100° C., a sample was obtained.

The permeability of the sample was measured by an Agilent E4991A impedance/material analyzer. The permeability thereof was 80 (at 1 MHz). The saturation magnetic flux density of the sample was measured by a BHU-60 BH curve tracer (Riken Denshi model). The saturation magnetic flux density thereof was 3941 Gauss.

### EXAMPLE 25

### Preparation of the Ferrite Magnetic Material (25) and Permeability and Saturation Magnetic Flux Density thereof

52.9 mol % of iron oxide, 7.35 mol % of nickel oxide, 16 mol % of zinc oxide, 9 mol % of copper oxide, 8.36 mol % of manganese oxide, 4.18 mol % of lithium carbonate, and 2.22 mol % of magnesium oxide were wet-mixed, calcined at 750° C., ball-milled and dried. After sintering at 1,100° C., a sample was obtained.

The permeability of the sample was measured by an Agilent E4991A impedance/material analyzer. The permeability thereof was 84 (at 1 MHz). The saturation magnetic flux density of the sample was measured by a BHU-60 BH curve tracer (Riken Denshi model). The saturation magnetic flux density thereof was 3858 Gauss.

### EXAMPLE 26

### Preparation of the Ferrite Magnetic Material (26) and Permeability and Saturation Magnetic Flux Density thereof

52.9 mol % of iron oxide, 7.35 mol % of nickel oxide, 16 mol % of zinc oxide, 8.63 mol % of copper oxide, 8.61 mol % of manganese oxide, 4.3 mol % of lithium carbonate, and 2.22 mol % of magnesium oxide were wet-mixed, calcined at 750° C., ball-milled and dried. After sintering at 1,100° C., a sample was obtained.

The permeability of the sample was measured by an Agilent E4991A impedance/material analyzer. The permeability thereof was 77 (at 1 MHz). The saturation magnetic flux density of the sample was measured by a BHU-60 BH curve tracer (Riken Denshi model). The saturation magnetic flux density thereof was 3801 Gauss.

### EXAMPLE 27

### Preparation of the Ferrite Magnetic Material (27) and Permeability and Saturation Magnetic Flux Density thereof

52.9 mol % of iron oxide, 7.35 mol % of nickel oxide, 16 mol % of zinc oxide, 8.25 mol % of copper oxide, 8.86 mol % of manganese oxide, 4.43 mol % of lithium carbonate, and 2.22 mol % of magnesium oxide were wet-mixed, calcined at 750° C., ball-milled and dried. After sintering at 1,200° C., a sample was obtained.

The permeability of the sample was measured by an Agilent E4991A impedance/material analyzer. The permeability thereof was 71 (at 1 MHz). The saturation magnetic flux density of the sample was measured by a BHU-60 BH curve tracer (Riken Denshi model). The saturation magnetic flux density thereof was 3864 Gauss.

### EXAMPLE 28

### Preparation of the Ferrite Magnetic Material (28) and Permeability and Saturation Magnetic Flux Density thereof

52.9 mol % of iron oxide, 7.35 mol % of nickel oxide, 16 mol % of zinc oxide, 8.25 mol % of copper oxide, 8.86 mol % of manganese oxide, 4.43 mol % of lithium carbonate, and 2.22 mol % of magnesium oxide were wet-mixed, calcined at 750° C., ball-milled and dried. After sintering at 1,150° C., a sample was obtained.

The permeability of the sample was measured by an Agilent E4991A impedance/material analyzer. The permeability thereof was 80 (at 1 MHz). The saturation magnetic flux density of the sample was measured by a BHU-60 BH curve tracer (Riken Denshi model). The saturation magnetic flux density thereof was 3912 Gauss.

### EXAMPLE 29

### Preparation of the Ferrite Magnetic Material (29) and Permeability and Saturation Magnetic Flux Density thereof

52.9 mol % of iron oxide, 7.35 mol % of nickel oxide, 16 mol % of zinc oxide, 7.88 mol % of copper oxide, 9.11 mol % of manganese oxide, 4.55 mol % of lithium carbonate, and 2.22 mol % of magnesium oxide were wet-mixed, calcined at 750° C., ball-milled and dried. After sintering at 1,150° C., a sample was obtained.

The permeability of the sample was measured by an Agilent E4991A impedance/material analyzer. The permeability thereof was 78 (at 1 MHz). The saturation magnetic flux density of the sample was measured by a BHU-60 BH curve tracer (Riken Denshi model). The saturation magnetic flux density thereof was 3951 Gauss.

### EXAMPLE 30

### Preparation of the Ferrite Magnetic Material (30) and Permeability and Saturation Magnetic Flux Density thereof

52.9 mol % of iron oxide, 7.35 mol % of nickel oxide, 16 mol % of zinc oxide, 7.5 mol % of copper oxide, 9.36 mol % of manganese oxide, 4.68 mol % of lithium carbonate, and 2.22 mol % of magnesium oxide were wet-mixed, calcined at 750° C., ball-milled and dried. After sintering at 1,100° C., a sample was obtained.

The permeability of the sample was measured by an Agilent E4991A impedance/material analyzer. The permeability thereof was 86 (at 1 MHz). The saturation magnetic flux density of the sample was measured by a BHU-60 BH curve tracer (Riken Denshi model). The saturation magnetic flux density thereof was 3969 Gauss.

### EXAMPLE 31

### Preparation of the Ferrite Magnetic Material (31) and Permeability and Saturation Magnetic Flux Density thereof

52.9 mol % of iron oxide, 7.35 mol % of nickel oxide, 16 mol % of zinc oxide, 8 mol % of copper oxide, 9.36 mol % of manganese oxide, 4.18 mol % of lithium carbonate, and 2.22 mol % of magnesium oxide were wet-mixed, calcined at 750° C., ball-milled and dried. After sintering at 1,100° C., a sample was obtained.

The permeability of the sample was measured by an Agilent E4991A impedance/material analyzer. The permeability thereof was 98 (at 1 MHz). The saturation magnetic flux density of the sample was measured by a BHU-60 BH curve tracer (Riken Denshi model). The saturation magnetic flux density thereof was 3932 Gauss.

### EXAMPLE 32

### Preparation of the Ferrite Magnetic Material (32) and Permeability and Saturation Magnetic Flux Density thereof

52.9 mol % of iron oxide, 7.35 mol % of nickel oxide, 16 mol % of zinc oxide, 6.75 mol % of copper oxide, 9.86 mol % of manganese oxide, 4.93 mol % of lithium carbonate, and 2.21 mol % of magnesium oxide were wet-mixed, calcined at 750° C., ball-milled and dried. After sintering at 1,100° C., a sample was obtained.

The permeability of the sample was measured by an Agilent E4991A impedance/material analyzer. The permeability thereof was 98 (at 1 MHz). The saturation magnetic flux density of the sample was measured by a BHU-60 BH curve tracer (Riken Denshi model). The saturation magnetic flux density thereof was 3954 Gauss.

### EXAMPLE 33

### Preparation of the Ferrite Magnetic Material (33) and Permeability and Saturation Magnetic Flux Density thereof

52.9 mol % of iron oxide, 7.35 mol % of nickel oxide, 16 mol % of zinc oxide, 6 mol % of copper oxide, 10.36 mol % of manganese oxide, 5.18 mol % of lithium carbonate, and 2.21 mol % of magnesium oxide were wet-mixed, calcined at 750° C., ball-milled and dried. After sintering at 1,100° C., a sample was obtained.

The permeability of the sample was measured by an Agilent E4991A impedance/material analyzer. The permeability thereof was 95 (at 1 MHz). The saturation magnetic flux density of the sample was measured by a BHU-60 BH curve tracer (Riken Denshi model). The saturation magnetic flux density thereof was 3884 Gauss.

### EXAMPLE 34

### Preparation of the Ferrite Magnetic Material (34) and Permeability and Saturation Magnetic Flux Density thereof

52.9 mol % of iron oxide, 7.35 mol % of nickel oxide, 16 mol % of zinc oxide, 5.25 mol % of copper oxide, 10.86 mol % of manganese oxide, 5.43 mol % of lithium carbonate, and 2.21 mol % of magnesium oxide were wet-mixed, calcined at 750° C., ball-milled and dried. After sintering at 1,150° C., a sample was obtained.

The permeability of the sample was measured by an Agilent E4991A impedance/material analyzer. The permeability thereof was 89 (at 1 MHz). The saturation magnetic flux density of the sample was measured by a BHU-60 BH curve tracer (Riken Denshi model). The saturation magnetic flux density thereof was 3877 Gauss.

### EXAMPLE 35

### Preparation of the Ferrite Magnetic Material (35) and Permeability and Saturation Magnetic Flux Density thereof

52.9 mol % of iron oxide, 7.35 mol % of nickel oxide, 16 mol % of zinc oxide, 4.5 mol % of copper oxide, 11.36 mol % of manganese oxide, 5.68 mol % of lithium carbonate, and 2.21 mol % of magnesium oxide were wet-mixed, calcined at 750° C., ball-milled and dried. After sintering at 1,100° C., a sample was obtained.

The permeability of the sample was measured by an Agilent E4991A impedance/material analyzer. The permeability thereof was 92 (at 1 MHz). The saturation magnetic flux density of the sample was measured by a BHU-60 BH curve tracer (Riken Denshi model). The saturation magnetic flux density thereof was 3843 Gauss.

### EXAMPLE 36

### Preparation of the Ferrite Magnetic Material (36) and Permeability and Saturation Magnetic Flux Density thereof

52.9 mol % of iron oxide, 7.35 mol % of nickel oxide, 16 mol % of zinc oxide, 3.75 mol % of copper oxide, 11.86 mol % of manganese oxide, 5.93 mol % of lithium carbonate, and 2.22 mol % of magnesium oxide were wet-mixed, calcined at 750° C., ball-milled and dried. After sintering at 1,200° C., a sample was obtained.

The permeability of the sample was measured by an Agilent E4991A impedance/material analyzer. The permeability thereof was 80 (at 1 MHz). The saturation magnetic flux density of the sample was measured by a BHU-60 BH curve tracer (Riken Denshi model). The saturation magnetic flux density thereof was 3808 Gauss.

### EXAMPLE 37

### Preparation of the Ferrite Magnetic Material (37) and Permeability and Saturation Magnetic Flux Density thereof

52.9 mol % of iron oxide, 7.35 mol % of nickel oxide, 16 mol % of zinc oxide, 3 mol % of copper oxide, 12.36 mol % of manganese oxide, 6.18 mol % of lithium carbonate, and 2.22 mol % of magnesium oxide were wet-mixed, calcined at 750° C., ball-milled and dried. After sintering at 1,200° C., a sample was obtained.

The permeability of the sample was measured by an Agilent E4991A impedance/material analyzer. The permeability thereof was 89 (at 1 MHz). The saturation magnetic flux density of the sample was measured by a BHU-60 BH curve tracer (Riken Denshi model). The saturation magnetic flux density thereof was 3758 Gauss.

### EXAMPLE 38

### Preparation of the Ferrite Magnetic Material (38) and Permeability and Saturation Magnetic Flux Density thereof

52.9 mol % of iron oxide, 8.35 mol % of nickel oxide, 16 mol % of zinc oxide, 4.9 mol % of copper oxide, 8.35 mol % of manganese oxide, 8 mol % of lithium carbonate, and 1.5 mol % of magnesium oxide were wet-mixed, calcined at 750° C., ball-milled and dried. After sintering at 1,100° C., a sample was obtained.

The permeability of the sample was measured by an Agilent E4991A impedance/material analyzer. The permeability thereof was 79 (at 1 MHz). The saturation magnetic flux density of the sample was measured by a BHU-60 BH curve tracer (Riken Denshi model). The saturation magnetic flux density thereof was 3652 Gauss.

### EXAMPLE 39

### Preparation of the Ferrite Magnetic Material (39) and Permeability and Saturation Magnetic Flux Density thereof

52.9 mol % of iron oxide, 8.35 mol % of nickel oxide, 16 mol % of zinc oxide, 8 mol % of copper oxide, 8.36 mol % of manganese oxide, 4.18 mol % of lithium carbonate, and 2.22 mol % of magnesium oxide were wet-mixed, calcined at 750° C., ball-milled and dried. After sintering at 1,150° C., a sample was obtained.

The permeability of the sample was measured by an Agilent E4991A impedance/material analyzer. The permeability thereof was 87 (at 1 MHz). The saturation magnetic flux density of the sample was measured by a BHU-60 BH curve tracer (Riken Denshi model). The saturation magnetic flux density thereof was 3934 Gauss.

### EXAMPLE 40

### Preparation of the Ferrite Magnetic Material (40) and Permeability and Saturation Magnetic Flux Density thereof

53.4 mol % of iron oxide, 8.1 mol % of nickel oxide, 16 mol % of zinc oxide, 4.9 mol % of copper oxide, 8.1 mol % of manganese oxide, 8 mol % of lithium carbonate, and 1.5 mol % of magnesium oxide were wet-mixed, calcined at 750° C., ball-milled and dried. After sintering at 1,100° C., a sample was obtained.

The permeability of the sample was measured by an Agilent E4991A impedance/material analyzer. The permeability thereof was 81 (at 1 MHz). The saturation magnetic flux density of the sample was measured by a BHU-60 BH curve tracer (Riken Denshi model). The saturation magnetic flux density thereof was 3631 Gauss.

### EXAMPLE 41

### Preparation of the Ferrite Magnetic Material (41) and Permeability and Saturation Magnetic Flux Density thereof

53.9 mol % of iron oxide, 7.85 mol % of nickel oxide, 16 mol % of zinc oxide, 4.9 mol % of copper oxide, 7.85 mol % of manganese oxide, 8 mol % of lithium carbonate, and 1.5 mol % of magnesium oxide were wet-mixed, calcined at 750° C., ball-milled and dried. After sintering at 1,100° C., a sample was obtained.

The permeability of the sample was measured by an Agilent E4991A impedance/material analyzer. The permeability thereof was 79 (at 1 MHz). The saturation magnetic flux density of the sample was measured by a BHU-60 BH curve tracer (Riken Denshi model). The saturation magnetic flux density thereof was 3638 Gauss.

### EXAMPLE 42

### Preparation of the Ferrite Magnetic Material (42) and Permeability and Saturation Magnetic Flux Density thereof

54.4 mol % of iron oxide, 7.6 mol % of nickel oxide, 16 mol % of zinc oxide, 4.9 mol % of copper oxide, 7.6 mol % of manganese oxide, 8 mol % of lithium carbonate, and 1.5 mol % of magnesium oxide were wet-mixed, calcined at 750° C., ball-milled and dried. After sintering at 1,100° C., a sample was obtained.

The permeability of the sample was measured by an Agilent E4991A impedance/material analyzer. The permeability thereof was 77 (at 1 MHz). The saturation magnetic flux density of the sample was measured by a BHU-60 BH curve tracer (Riken Denshi model). The saturation magnetic flux density thereof was 3515 Gauss.

### EXAMPLE 43

### Preparation of the Ferrite Magnetic Material (43) and Permeability and saturation magnetic flux density thereof

48.4 mol % of iron oxide, 6.6 mol % of nickel oxide, 13 mol % of zinc oxide, 6.4 mol % of copper oxide, 10.6 mol % of manganese carbonate, 8.6 mol % of lithium carbonate, and 6.4 mol % of magnesium oxide were wet-mixed, calcined at 750° C., ball-milled and dried. After sintering at 1,100° C., a sample was obtained.

The permeability of the sample was measured by an Agilent E4991A impedance/material analyzer. The permeability thereof was 47 (at 1 MHz). The saturation magnetic flux density of the sample was measured by a BHU-60 BH curve tracer (Riken Denshi model). The saturation magnetic flux density thereof was 2803 Gauss.

### EXAMPLE 44

### Preparation of the Ferrite Magnetic Material (44) and Permeability and Saturation Magnetic Flux Density thereof

48.4 mol % of iron oxide, 8.6 mol % of nickel oxide, 8.6 mol % of zinc oxide, 8.6 mol % of copper oxide, 8.6 mol % of manganese carbonate, 8.6 mol % of lithium carbonate, and 8.6 mol % of magnesium oxide were wet-mixed, calcined at 750° C., ball-milled and dried. After sintering at 1,050° C., a sample was obtained.

The permeability of the sample was measured by an Agilent E4991A impedance/material analyzer. The permeability thereof was 38 (at 1 MHz). The saturation magnetic flux density of the sample was measured by a BHU-60 BH curve tracer (Riken Denshi model). The saturation magnetic flux density thereof was 3000 Gauss.

### EXAMPLE 45

### Preparation of the Ferrite Magnetic Material (45) and Permeability and Saturation Magnetic Flux Density thereof

48.4 mol % of iron oxide, 8.6 mol % of nickel oxide, 10 mol % of zinc oxide, 7.9 mol % of copper oxide, 8.6 mol % of manganese carbonate, 8.6 mol % of lithium carbonate, and 7.9 mol % of magnesium oxide were wet-mixed, calcined at 750° C., ball-milled and dried. After sintering at 1,100° C., a sample was obtained.

The permeability of the sample was measured by an Agilent E4991A impedance/material analyzer. The permeability thereof was 45 (at 1 MHz). The saturation magnetic flux density of the sample was measured by a BHU-60 BH curve tracer (Riken Denshi model). The saturation magnetic flux density thereof was 3114 Gauss.

### EXAMPLE 46

### Preparation of the Ferrite Magnetic Material (46) and Permeability and Saturation Magnetic Flux Density thereof

48.4 mol % of iron oxide, 8.6 mol % of nickel oxide, 11 mol % of zinc oxide, 7.4 mol % of copper oxide, 8.6 mol % of manganese carbonate, 8.6 mol % of lithium carbonate, and 7.4 mol % of magnesium oxide were wet-mixed, calcined at 750° C., ball-milled and dried. After sintering at 1,050° C., a sample was obtained.

The permeability of the sample was measured by an Agilent E4991A impedance/material analyzer. The permeability thereof was 50 (at 1 MHz). The saturation magnetic flux density of the sample was measured by a BHU-60 BH curve tracer (Riken Denshi model). The saturation magnetic flux density thereof was 3209 Gauss.

### EXAMPLE 47

### Preparation of the Ferrite Magnetic Material (47) and Permeability and Saturation Magnetic Flux Density thereof

48.4 mol % of iron oxide, 8.6 mol % of nickel oxide, 12 mol % of zinc oxide, 6.9 mol % of copper oxide, 8.6 mol % of manganese carbonate, 8.6 mol % of lithium carbonate, and 6.9 mol % of magnesium oxide were wet-mixed, calcined at 750° C., ball-milled and dried. After sintering at 1,100° C., a sample was obtained.

The permeability of the sample was measured by an Agilent E4991A impedance/material analyzer. The permeability thereof was 53 (at 1 MHz). The saturation magnetic flux density of the sample was measured by a BHU-60 BH curve tracer (Riken Denshi model). The saturation magnetic flux density thereof was 3105 Gauss.

### EXAMPLE 48

### Preparation of the Ferrite Magnetic Material (48) and Permeability and Saturation Magnetic Flux Density thereof

48.4 mol % of iron oxide, 8.6 mol % of nickel oxide, 13 mol % of zinc oxide, 6.4 mol % of copper oxide, 8.6 mol % of manganese carbonate, 8.6 mol % of lithium carbonate, and 6.4 mol % of magnesium oxide were wet-mixed, calcined at 750° C., ball-milled and dried. After sintering at 1,100° C., a sample was obtained.

The permeability of the sample was measured by an Agilent E4991A impedance/material analyzer. The permeability thereof was 68 (at 1 MHz). The saturation magnetic flux density of the sample was measured by a BHU-60 BH curve tracer (Riken Denshi model). The saturation magnetic flux density thereof was 3234 Gauss.

### EXAMPLE 49

### Preparation of the Ferrite Magnetic Material (49) and Permeability and Saturation Magnetic Flux Density thereof

48.4 mol % of iron oxide, 8.6 mol % of nickel oxide, 14 mol % of zinc oxide, 5.9 mol % of copper oxide, 8.6 mol % of manganese carbonate, 8.6 mol % of lithium carbonate, and 5.9 mol % of magnesium oxide were wet-mixed, calcined at 750° C., ball-milled and dried. After sintering at 1,100° C., a sample was obtained.

The permeability of the sample was measured by an Agilent E4991A impedance/material analyzer. The permeability thereof was 78 (at 1 MHz). The saturation magnetic flux density of the sample was measured by a BHU-60 BH curve tracer (Riken Denshi model). The saturation magnetic flux density thereof was 3213 Gauss.

### EXAMPLE 50

### Preparation of the Ferrite Magnetic Material (50) and Permeability and Saturation Magnetic Flux Density thereof

48.4 mol % of iron oxide, 8.6 mol % of nickel oxide, 15 mol % of zinc oxide, 5.4 mol % of copper oxide, 8.6 mol % of manganese carbonate, 8.6 mol % of lithium carbonate, and 5.4 mol % of magnesium oxide were wet-mixed, calcined at 750° C., ball-milled and dried. After sintering at 1,100° C., a sample was obtained.

The permeability of the sample was measured by an Agilent E4991A impedance/material analyzer. The permeability thereof was 83 (at 1 MHz). The saturation magnetic flux density of the sample was measured by a BHU-60 BH curve tracer (Riken Denshi model). The saturation magnetic flux density thereof was 3198 Gauss.

### EXAMPLE 51

### Preparation of the Ferrite Magnetic Material (51) and Permeability and Saturation Magnetic Flux Density thereof

48.4 mol % of iron oxide, 8.6 mol % of nickel oxide, 13 mol % of zinc oxide, 6.4 mol % of copper oxide, 8.6 mol % of manganese carbonate, 8.6 mol % of lithium carbonate, and 6.4 mol % of magnesium oxide were wet-mixed, calcined at 750° C., ball-milled and dried. After sintering at 1,100° C., a sample was obtained.

The permeability of the sample was measured by an Agilent E4991A impedance/material analyzer. The permeability thereof was 43 (at 1 MHz). The saturation magnetic flux density of the sample was measured by a BHU-60 BH curve tracer (Riken Denshi model). The saturation magnetic flux density thereof was 2806 Gauss.

### EXAMPLE 52

### Preparation of the Ferrite Magnetic Material (52) and Permeability and Saturation Magnetic Flux Density thereof

49.4 mol % of iron oxide, 6.6 mol % of nickel oxide, 13 mol % of zinc oxide, 6.4 mol % of copper oxide, 9.6 mol % of manganese carbonate, 8.6 mol % of lithium carbonate, and 6.4 mol % of magnesium oxide were wet-mixed, calcined at 750° C., ball-milled and dried. After sintering at 1,100° C., a sample was obtained.

The permeability of the sample was measured by an Agilent E4991A impedance/material analyzer. The permeability thereof was 49 (at 1 MHz). The saturation magnetic flux density of the sample was measured by a BHU-60 BH curve tracer (Riken Denshi model). The saturation magnetic flux density thereof was 2840 Gauss.

### EXAMPLE 53

### Preparation of the Ferrite Magnetic Material (53) and Permeability and Saturation Magnetic Flux Density thereof

50.4 mol % of iron oxide, 6.6 mol % of nickel oxide, 13 mol % of zinc oxide, 6.4 mol % of copper oxide, 8.6 mol % of manganese carbonate, 8.6 mol % of lithium carbonate, and 6.4 mol % of magnesium oxide were wet-mixed, calcined at 750° C., ball-milled and dried. After sintering at 1,100° C., a sample was obtained.

The permeability of the sample was measured by an Agilent E4991A impedance/material analyzer. The permeability thereof was 48 (at 1 MHz). The saturation magnetic flux density of the sample was measured by a BHU-60 BH curve tracer (Riken Denshi model). The saturation magnetic flux density thereof was 2913 Gauss.

### EXAMPLE 54

### Preparation of the Ferrite Magnetic Material (54) and Permeability and Saturation Magnetic Flux Density thereof

48.4 mol % of iron oxide, 8.6 mol % of nickel oxide, 8.6 mol % of zinc oxide, 8.6 mol % of copper oxide, 8.6 mol % of manganese oxide, 8.6 mol % of lithium oxide, and 6.4 mol % of magnesium oxide were wet-mixed, calcined at 750° C., ball-milled and dried. After sintering at 900° C., a sample was obtained.

The permeability of the sample was measured by an Agilent E4991A impedance/material analyzer. The permeability thereof was 34 (at 1 MHz). The saturation magnetic flux density of the sample was measured by a BHU-60 BH curve tracer (Riken Denshi model). The saturation magnetic flux density thereof was 2964 Gauss.

### EXAMPLE 55

### Preparation of the Ferrite Magnetic Material (55) and Permeability and Saturation Magnetic Flux Density thereof

52.9 mol % of iron oxide, 8.35 mol % of nickel oxide, 16 mol % of zinc oxide, 4.9 mol % of copper oxide, 8.35 mol % of manganese oxide, 8 mol % of lithium carbonate, 1.5 mol % of magnesium oxide, and 0.05 wt % of bismuth oxide were wet-mixed, calcined at 750° C., ball-milled and dried. After sintering at 1,050° C., a sample was obtained.

The permeability of the sample was measured by an Agilent E4991A impedance/material analyzer. The permeability thereof was 85 (at 1 MHz). The saturation magnetic flux density of the sample was measured by a BHU-60 BH curve tracer (Riken Denshi model). The saturation magnetic flux density thereof was 3581 Gauss.

### EXAMPLE 56

### Preparation of the Ferrite Magnetic Material (56) and Permeability and Saturation Magnetic Flux Density thereof

52.9 mol % of iron oxide, 8.35 mol % of nickel oxide, 16 mol % of zinc oxide, 4.9 mol % of copper oxide, 8.35 mol % of manganese oxide, 8 mol % of lithium carbonate, 1.5 mol % of magnesium oxide, and 0.1 wt % of bismuth oxide were wet-mixed, calcined at 750° C., ball-milled and dried. After sintering at 1,000° C., a sample was obtained.

The permeability of the sample was measured by an Agilent E4991A impedance/material analyzer. The permeability thereof was 88 (at 1 MHz). The saturation magnetic flux density of the sample was measured by a BHU-60 BH curve tracer (Riken Denshi model). The saturation magnetic flux density thereof was 3646 Gauss.

### EXAMPLE 57

### Preparation of the Ferrite Magnetic Material (57) and Permeability and Saturation Magnetic Flux Density thereof

52.9 mol % of iron oxide, 8.35 mol % of nickel oxide, 16 mol % of zinc oxide, 4.9 mol % of copper oxide, 8.35 mol % of manganese oxide, 8 mol % of lithium carbonate, 1.5 mol % of magnesium oxide, and 0.2 wt % of bismuth oxide were wet-mixed, calcined at 750° C., ball-milled and dried. After sintering at 1,000° C., a sample was obtained.

The permeability of the sample was measured by an Agilent E4991A impedance/material analyzer. The permeability thereof was 93 (at 1 MHz). The saturation magnetic flux density of the sample was measured by a BHU-60 BH curve tracer (Riken Denshi model). The saturation magnetic flux density thereof was 3675 Gauss.

### EXAMPLE 58

### Preparation of the Ferrite Magnetic Material (58) and Permeability and Saturation Magnetic Flux Density thereof

52.9 mol % of iron oxide, 8.35 mol % of nickel oxide, 16 mol % of zinc oxide, 4.9 mol % of copper oxide, 8.35 mol % of manganese oxide, 8 mol % of lithium carbonate, 1.5 mol % of magnesium oxide, and 0.3 wt % of bismuth oxide were wet-mixed, calcined at 750° C., ball-milled and dried. After sintering at 930° C., a sample was obtained.

The permeability of the sample was measured by an Agilent E4991A impedance/material analyzer. The permeability thereof was 77 (at 1 MHz). The saturation magnetic flux density of the sample was measured by a BHU-60 BH curve tracer (Riken Denshi model). The saturation magnetic flux density thereof was 3658 Gauss.

### EXAMPLE 59

### Preparation of the Ferrite Magnetic Material (59) and Permeability and Saturation Magnetic Flux Density thereof

52.9 mol % of iron oxide, 8.35 mol % of nickel oxide, 16 mol % of zinc oxide, 4.9 mol % of copper oxide, 8.35 mol % of manganese oxide, 8 mol % of lithium carbonate, 1.5 mol % of magnesium oxide, and 0.4 wt % of bismuth oxide were wet-mixed, calcined at 750° C., ball-milled and dried. After sintering at 930° C., a sample was obtained.

The permeability of the sample was measured by an Agilent E4991A impedance/material analyzer. The permeability thereof was 87 (at 1 MHz). The saturation magnetic flux density of the sample was measured by a BHU-60 BH curve tracer (Riken Denshi model). The saturation magnetic flux density thereof was 3776 Gauss.

### EXAMPLE 60

### Preparation of the Ferrite Magnetic Material (60) and Permeability and Saturation Magnetic Flux Density thereof

52.9 mol % of iron oxide, 8.35 mol % of nickel oxide, 16 mol % of zinc oxide, 4.9 mol % of copper oxide, 8.35 mol % of manganese oxide, 8 mol % of lithium carbonate, 1.5 mol % of magnesium oxide, and 0.5 wt % of bismuth oxide were wet-mixed, calcined at 750° C., ball-milled and dried. After sintering at 930° C., a sample was obtained.

The permeability of the sample was measured by an Agilent E4991A impedance/material analyzer. The permeability thereof was 88 (at 1 MHz). The saturation magnetic flux density of the sample was measured by a BHU-60 BH curve tracer (Riken Denshi model). The saturation magnetic flux density thereof was 3736 Gauss.

### EXAMPLE 61

### Preparation of the Ferrite Magnetic Material (61) and Permeability and Saturation Magnetic Flux Density thereof

52.9 mol % of iron oxide, 7.35 mol % of nickel oxide, 16 mol % of zinc oxide, 7.5 mol % of copper oxide, 9.36 mol % of manganese oxide, 4.68 mol % of lithium carbonate, 2.22 mol % of magnesium oxide, and 0.3 wt % of bismuth oxide were wet-mixed, calcined at 750° C., ball-milled and dried. After sintering at 970° C., a sample was obtained.

The permeability of the sample was measured by an Agilent E4991A impedance/material analyzer. The permeability thereof was 86 (at 1 MHz). The saturation magnetic flux density of the sample was measured by a BHU-60 BH curve tracer (Riken Denshi model). The saturation magnetic flux density thereof was 3991 Gauss.

### EXAMPLE 62

### Preparation of the Ferrite Magnetic Material (62) and Permeability and Saturation Magnetic Flux Density thereof

52.9 mol % of iron oxide, 7.35 mol % of nickel oxide, 16 mol % of zinc oxide, 7.5 mol % of copper oxide, 9.36 mol % of manganese oxide, 4.68 mol % of lithium carbonate, 2.22 mol % of magnesium oxide, and 0.4 wt % of bismuth oxide were wet-mixed, calcined at 750° C., ball-milled and dried. After sintering at 970° C., a sample was obtained.

The permeability of the sample was measured by an Agilent E4991A impedance/material analyzer. The permeability thereof was 83 (at 1 MHz). The saturation magnetic flux density of the sample was measured by a BHU-60 BH curve tracer (Riken Denshi model). The saturation magnetic flux density thereof was 3813 Gauss.

### EXAMPLE 63

### Preparation of the Ferrite Magnetic Material (63) and Permeability and Saturation Magnetic Flux Density thereof

52.9 mol % of iron oxide, 7.35 mol % of nickel oxide, 16 mol % of zinc oxide, 7.5 mol % of copper oxide, 9.36 mol % of manganese oxide, 4.68 mol % of lithium carbonate, 2.22 mol % of magnesium oxide, and 0.5 wt % of bismuth oxide were wet-mixed, calcined at 750° C., ball-milled and dried. After sintering at 970° C., a sample was obtained.

The permeability of the sample was measured by an Agilent E4991A impedance/material analyzer. The permeability thereof was 81 (at 1 MHz). The saturation magnetic flux density of the sample was measured by a BHU-60 BH curve tracer (Riken Denshi model). The saturation magnetic flux density thereof was 3913 Gauss.

### EXAMPLE 64

### Preparation of the Ferrite Magnetic Material (64) and Permeability and Saturation Magnetic Flux Density thereof

52.9 mol % of iron oxide, 7.35 mol % of nickel oxide, 16 mol % of zinc oxide, 7.5 mol % of copper oxide, 9.36 mol % of manganese oxide, 4.68 mol % of lithium carbonate, 2.22 mol % of magnesium oxide, and 0.6 wt % of bismuth oxide were wet-mixed, calcined at 750° C., ball-milled and dried. After sintering at 950° C., a sample was obtained.

The permeability of the sample was measured by an Agilent E4991A impedance/material analyzer. The permeability thereof was 88 (at 1 MHz). The saturation magnetic flux density of the sample was measured by a BHU-60 BH curve tracer (Riken Denshi model). The saturation magnetic flux density thereof was 3947 Gauss.

### EXAMPLE 65

### Preparation of the Ferrite Magnetic Material (65) and Permeability and Saturation Magnetic Flux Density thereof

52.9 mol % of iron oxide, 7.35 mol % of nickel oxide, 16 mol % of zinc oxide, 7.5 mol % of copper oxide, 9.36 mol % of manganese oxide, 4.68 mol % of lithium carbonate, 2.22 mol % of magnesium oxide, and 0.7 wt % of bismuth oxide were wet-mixed, calcined at 750° C., ball-milled and dried. After sintering at 950° C., a sample was obtained.

The permeability of the sample was measured by an Agilent E4991A impedance/material analyzer. The permeability thereof was 89 (at 1 MHz). The saturation magnetic flux density of the sample was measured by a BHU-60 BH curve tracer (Riken Denshi model). The saturation magnetic flux density thereof was 3964 Gauss.

### EXAMPLE 66

### Preparation of the Ferrite Magnetic Material (66) and Permeability and Saturation Magnetic Flux Density thereof

52.9 mol % of iron oxide, 7.35 mol % of nickel oxide, 16 mol % of zinc oxide, 7.5 mol % of copper oxide, 9.36 mol % of manganese oxide, 4.68 mol % of lithium carbonate, 2.22 mol % of magnesium oxide, and 0.8 wt % of bismuth oxide were wet-mixed, calcined at 750° C., ball-milled and dried. After sintering at 950° C., a sample was obtained.

The permeability of the sample was measured by an Agilent E4991A impedance/material analyzer. The permeability thereof was 91 (at 1 MHz). The saturation magnetic flux density of the sample was measured by a BHU-60 BH curve tracer (Riken Denshi model). The saturation magnetic flux density thereof was 3952 Gauss.

### EXAMPLE 67

### Preparation of the Ferrite Magnetic Material (67) and Permeability and Saturation Magnetic Flux Density thereof

47.96 mol % of iron oxide, 8.6 mol % of nickel oxide, 8.49 mol % of zinc oxide, 8.56 mol % of copper oxide, 8.48 mol % of manganese oxide, 8.52 mol % of lithium oxide, 8.65 mol % of magnesium oxide, and 0.73 mol % of cobalt oxide were wet-mixed, calcined at 750° C., ball-milled and dried. After sintering at 1,050° C., a sample was obtained.

The permeability of the sample was measured by an Agilent E4991A impedance/material analyzer. The permeability thereof was 39 (at 1 MHz). The saturation magnetic flux density of the sample was measured by a BHU-60 BH curve tracer (Riken Denshi model). The saturation magnetic flux density thereof was 2709 Gauss.

### EXAMPLE 68

### Preparation of the Ferrite Magnetic Material (68) and Permeability and Saturation Magnetic Flux Density thereof

47.61 mol % of iron oxide, 8.54 mol % of nickel oxide, 8.43 mol % of zinc oxide, 8.5 mol % of copper oxide, 8.42 mol % of manganese oxide, 8.46 mol % of lithium oxide, 8.59 mol % of magnesium oxide, and 1.46 mol % of cobalt oxide were wet-mixed, calcined at 750° C., ball-milled and dried. After sintering at 1,050° C., a sample was obtained.

The permeability of the sample was measured by an Agilent E4991A impedance/material analyzer. The permeability thereof was 37 (at 1 MHz). The saturation magnetic flux density of the sample was measured by a BHU-60 BH curve tracer (Riken Denshi model). The saturation magnetic flux density thereof was 2510 Gauss.

### EXAMPLE 69

### Preparation of the Ferrite Magnetic Material (69) and Permeability and Saturation Magnetic Flux Density thereof

47.93 mol % of iron oxide, 8.59 mol % of nickel oxide, 8.48 mol % of zinc oxide, 8.56 mol % of copper oxide, 8.47 mol % of manganese oxide, 8.56 mol % of lithium carbonate, 8.65 mol % of magnesium oxide, and 0.76 mol % of cobalt oxide were wet-mixed, calcined at 750° C., ball-milled and dried. After sintering at 890° C., a sample was obtained.

The permeability of the sample was measured by an Agilent E4991A impedance/material analyzer. The permeability thereof was 31 (at 1 MHz). The saturation magnetic flux density of the sample was measured by a BHU-60 BH curve tracer (Riken Denshi model). The saturation magnetic flux density thereof was 2916 Gauss.

### EXAMPLE 70

### Preparation of the Ferrite Magnetic Material (70) and Permeability and Saturation Magnetic Flux Density thereof

47.57 mol % of iron oxide, 8.53 mol % of nickel oxide, 8.42 mol % of zinc oxide, 8.49 mol % of copper oxide, 8.41 mol % of manganese oxide, 8.49 mol % of lithium carbonate, 8.58 mol % of magnesium oxide, and 1.51 mol % of cobalt oxide were wet-mixed, calcined at 750° C., ball-milled and dried. After sintering at 950° C., a sample was obtained.

The permeability of the sample was measured by an Agilent E4991A impedance/material analyzer. The permeability thereof was 20 (at 1 MHz). The saturation magnetic flux density of the sample was measured by a BHU-60 BH curve tracer (Riken Denshi model). The saturation magnetic flux density thereof was 2478 Gauss.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A ferrite magnetic material having the following formula:
(NiₐCu_{b}Zn_{c}Mn_{d}MgₑLi_{f}Co_{g})ₓFe_{y}O_{z}
wherein x+y=2.5-3.5, y+z=5.5-6.5, y=1.70-2.40, a=0.08-0.22, b=0.03-0.23, c=0.09-0.42, d=0.12-0.31, e=0.01-0.21, f=0.06-0.42 and g=0-0.06.

2. The ferrite magnetic material as claimed in claim 1, wherein x+y=2.5-3.5, y+z=5.5-6.5, y=1.70-2.30, a=0.13-0.22, b=0.07-0.20, c=0.09-0.40, d=0.13-0.22, e=0.01-0.21, f=0.29-0.40 and g=0.

3. The ferrite magnetic material as claimed in claim 1, wherein x+y=2.5-3.5, y+z=5.5-6.5, y=1.90-2.40, a=0.08-0.22, b=0.03-0.23, c=0.32-0.42, d=0.13-0.31, e=0.01-0.08, f=0.14-0.42 and g=0.

4. The ferrite magnetic material as claimed in claim 1, wherein x+y=2.5-3.5, y+z=5.5-6.5, y=1.70-2.30, a=0.09-0.20, b=0.07-0.20, c=0.13-0.32, d=0.13-0.24, e=0.07-0.20, f=0.29-0.38 and g=0.

5. The ferrite magnetic material as claimed in claim 1, wherein x+y=2.5-3.5, y+z=5.5-6.5, y=1.70-2.10, a=0.13-0.20, b=0.13-0.20, c=0.13-0.20, d=0.13-0.20, e=0.13-0.20, f=0.29-0.36 and g=0.

6. The ferrite magnetic material as claimed in claim 1, wherein x+y=2.5-3.5, y+z=5.5-6.5, y=1.90-2.30, a=0.12-0.22, b=0.07-0.20, c=0.30-0.39, d=0.13-0.24, e=0.01-0.08, f=0.06-0.21 and g=0.

7. The ferrite magnetic material as claimed in claim 1, wherein x+y=2.5-3.5, y+z=5.5-6.5, y=1.70-2.10, a=0.12-0.20, b=0.12-0.20, c=0.12-0.20, d=0.12-0.20, e=0.12-0.20, f=0.27-0.37 and g=0-0.06.
